(19) United States
(12) Patent Application Publication
(10) Pub. No.: US 2009/0001687 A1
(43) Pub. Date: Jan. 1, 2009

(54) Securing device for bicycle accessories

(76) Inventor: I-Li Chao, Taichung (TW)

Correspondence Address: GENIUS ELECTRONIC OPTICAL CO., LTD., P.O. BOX 215, TAICHUNG, 40099, TW

(21) Appl. No.: 12/155,416

(22) Filed: Jun. 4, 2008

(30) Foreign Application Priority Data
Jun. 29, 2007 (TW) 096210710

(51) Int. Cl. B62J 39/00

(52) U.S. Cl. 280/288.4

(57) ABSTRACT

A securing device for bicycle accessories includes a C-shaped collar which is mounted to a bicycle frame and includes an opening via which the bicycle frame is mounted by the collar. An extension extending from one of two ends of the opening and a plurality of positioning grooves are defined in an underside of the extension. A support member is fixed on the collar so as to connect a bicycle lamp thereon. A lever is pivotably connected to the support member by a pin and includes an eccentric portion which is removably in contact with the support member. A locking member is pivotably connected to the lever at an eccentric position relative to the pin. The locking member is engaged with one of the positioning grooves so as to adjust a size of an inner diameter of the collar.

### FIELD OF THE INVENTION

The present invention relates to a securing device for bicycle accessories such as a lamp and more particularly, to a securing device which is easily operated and cooperated with bicycle frame of different sizes.

### BACKGROUND OF THE INVENTION

A conventional securing device for securing a bicycle accessory such as a lamp to the bicycle frame generally includes a support member on which the lamp or other item is connected, and a lever which has an eccentric portion. A collar is cooperated with the support member and includes a flexible portion which contacts the eccentric portion. Each of the flexible portion and the eccentric portion has a toothed portion and the two respective toothed portions are engaged with each other.

By operating the lever, the collar can be secured to the bicycle frame of different sizes. However, the range of the inner diameter of the collar is limited and can only be connected to some parts of the bicycle frame. Besides, the securing device cannot be released from the bicycle frame quickly, and this restricts the user to carry the lamp and the securing device when needed.

The present invention intends to provide a securing device for securing a bicycle accessory to bicycle frames of different sizes and the collar of the securing device can be easily change its size so as to mount to or dismount from the bicycle frames.

### SUMMARY OF THE INVENTION

The present invention relates to a securing device for bicycle accessories and comprises a C-shaped collar including a receiving space and an opening which communicates with the receiving space. An extension extends from one of two ends of the opening and has a plurality of positioning grooves defined in an underside thereof. A support member is fixed on the collar and located above the opening. A lever is pivotably connected to the support member by a pin and includes an eccentric portion which is removably in contact with the support member. A locking member is pivotably connected to the lever at an eccentric position relative to the pin. The locking member is engaged with one of the positioning grooves so as to adjust a size of an inner diameter of the collar.

The primary object of the present invention is to provide a securing device for securing a bicycle accessory to the bicycle frame, wherein the inner diameter of the collar can be quickly adjusted by operation of the lever.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the securing device of the present invention;

FIG. 2 is a perspective view to show the securing device of the present invention;

FIG. 3 is a side view to show the securing device of the present invention wherein the locking member is disengaged from the positioning grooves, and

FIG. 4 is a side view to show the securing device of the present invention wherein the locking member is engaged from one the positioning grooves.

### DETAILED DESCRIPTION OF THE PREFERRED EMBODIMENT

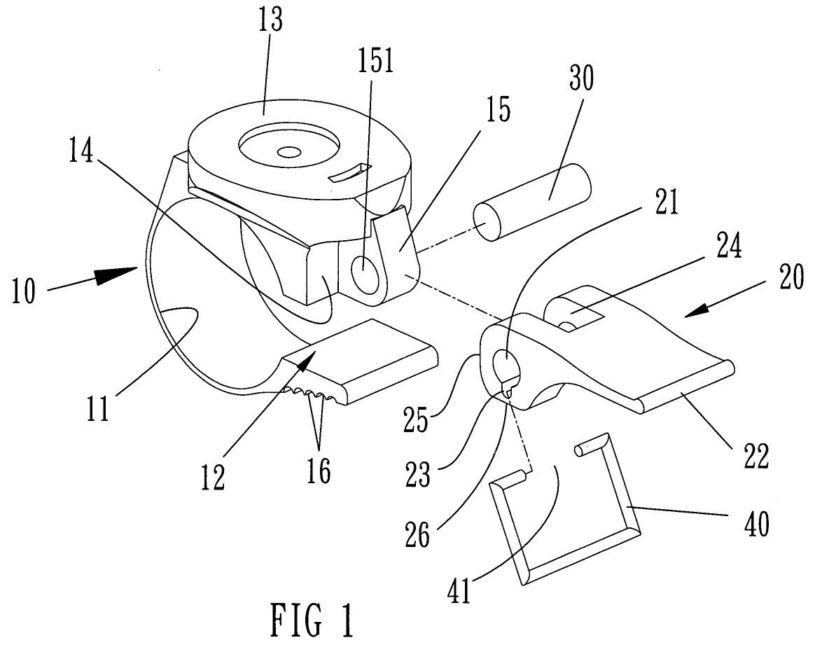

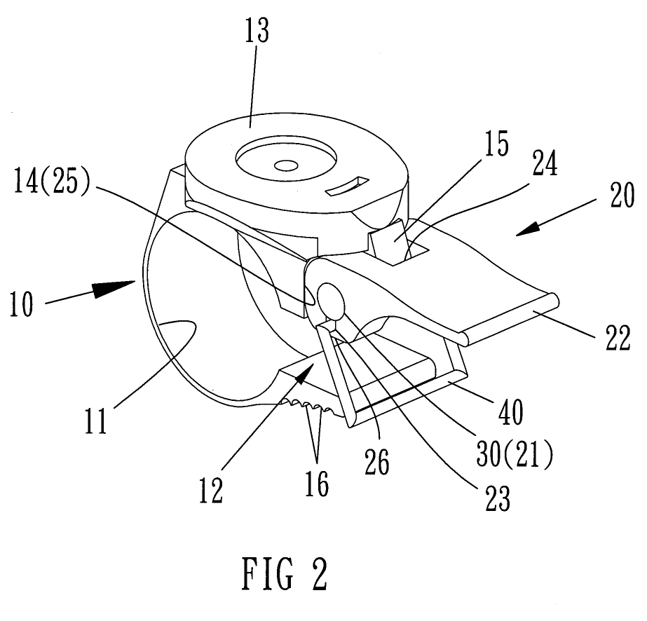

Referring to FIGS. 1 to 3, the securing device for bicycle accessories comprises a C-shaped collar 10 which includes a receiving space 11 and a first opening 12 which communicates with the receiving space 11. An extension extends from one of two ends of the opening 12 and a plurality of positioning grooves 16 are defined in an underside of the extension. A support member 13 is fixed on the collar 10 and located above the first opening 12. A bicycle accessory such as a lamp (not shown) is connected to the support member 13 and the C-shaped collar 10 is mounted to a bicycle frame (not shown) which is received in the receiving space 11 via the first opening 12. A protrusion 15 extends from the support member 13 and two first flat surfaces 14 (only one is shown) are defined beside the protrusion 15. A first passage 151 is defined through the protrusion 15.

A lever 20 includes an eccentric portion at one end and a handle 22 extends from the eccentric portion of the lever 20. The lever 20 includes a recess 24 defined in the eccentric portion and the protrusion 15 is received in the recess 24. Two lugs separated by the recess 24 each include a second passage 21. A notch 23 is defined in an inner periphery of the second passage 21. A pin 30 extends through the first and second passages 151, 21. The two lugs of the eccentric portion each have a second flat surface 25 and a third flat surface 26, when the second flat surface 25 is engaged with the first flat surface 14, the collar 10 is in loosened position, when the third surface 26 is engaged with the first flat surface 14, the collar 10 is tightened position.

A locking member 40 is a substantially U-shaped member with a second opening 41 and two insertions extend from two ends of the second opening 41. The two insertions are engaged with the notch 23 in the inner periphery of the second passage 21 and the locking member 40 is pivotably connected to the lever 20 at an eccentric position relative to the pin 30. The locking member 40 is engaged with one of the positioning grooves 16 so as to adjust a size of an inner diameter of the collar 10.

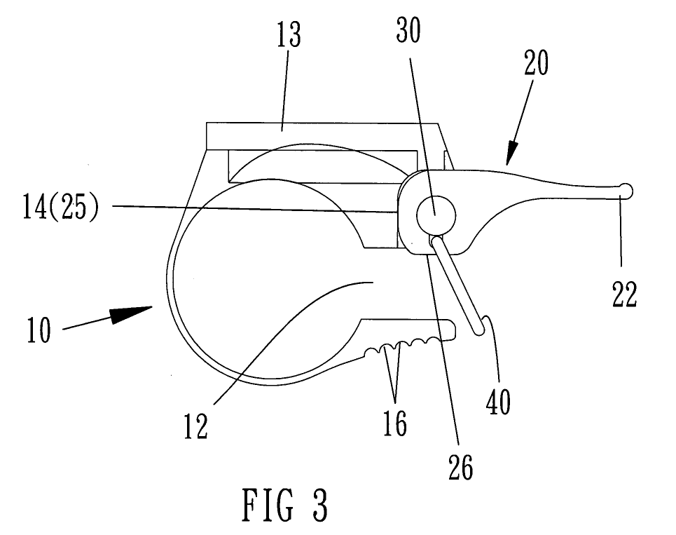

As shown in FIG. 3, when the second flat surface 25 is matched with first flat surface 14, the handle 22 is in horizontal position and the locking member 40 does not engaged with the positioning grooves 16. In this status, the bicycle frame can be easily received in the receiving space 11 via the first opening 12.

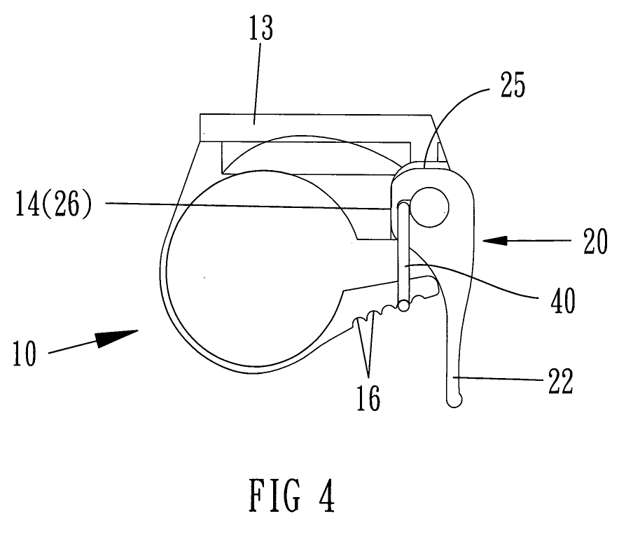

As shown in FIG. 4, when engaging the locking member 40 with one of the positioning grooves 16, and pivoting the handle 22 about the pin 30, the second flat surface 25 is removed from the first flat surface 14 and the third flat surface 26 is engaged with the first flat surface 14. The eccentric portion pulls the locking member 40 to pull the extension toward the support member 13 to tighten the C-shaped collar 10 to secure the support member 13 on the bicycle frame.

By using the locking member 40, the securing device can be quickly tightened or loosened by operating the handle 22 to position the locking member 40.

While we have shown and described the embodiment in accordance with the present invention, it should be clear to those skilled in the art that further embodiments may be made without departing from the scope of the present invention.

What is claimed is:

1. A securing device for bicycle accessories, comprising:
a C-shaped collar including a receiving space and a first opening which communicates with the receiving space, an extension extending from one of two ends of the first opening and a plurality of positioning grooves 16 defined in an underside of the extension;
a support member fixed on the collar and located above the first opening;
a lever pivotably connected to the support member by a pin and including an eccentric portion which is removably in contact with the support member, and
a locking member pivotably connected to the lever at an eccentric position relative to the pin, the locking member engaged with one of the positioning grooves so as to adjust a size of an inner diameter of the collar.

2. The device as claimed in claim 1, wherein the support member includes a first flat surface which faces the eccentric portion of the lever, the eccentric portion includes a second flat surface and a third flat surface, when the second flat surface is engaged with the first flat surface, the collar is in loosened position, when the third surface is engaged with the first flat surface, the collar is tightened position.

3. The device as claimed in claim 1, wherein a protrusion extends from the support member and the lever includes a recess in which the protrusion is received, the protrusion includes a first passage and two lugs separated by the recess each include a second passage, the pin extends through the first and second passages.

4. The device as claimed in claim 3, wherein a notch is defined in an inner periphery of the second passage and the locking member includes two insertions which are separated by a second opening, the eccentric portion of the lever is located in the second opening and the two insertions are engaged with the notch.
